(19) United States
(12) Patent Application Publication
(10) Pub. No.: US 2004/0261415 A1
(43) Pub. Date: Dec. 30, 2004

(54) Motor-driven compressor-alternator unit with additional compressed air injection operating with mono and multiple energy

(75) Inventors: Guy Negre, Carros Cedex (FR); Cyril Negre, Carros Cedex (FR)

Correspondence Address: GREENBLUM & BERNSTEIN, P.L.C., 1950 ROLAND CLARKE PLACE, RESTON, VA, 20191, US

(73) Assignee: MDI-MOTOR DEVELOPMENT INTERNATIONAL S.A.

(21) Appl. No.: 10/830,005

(22) Filed: Apr. 23, 2004

Related U.S. Application Data
(63) Continuation of application No. PCT/FR02/03667, filed on Oct. 25, 2002.

(30) Foreign Application Priority Data
Oct. 25, 2001 (FR) 01/13798

(51) Int. Cl. F02G 1/00

(52) U.S. Cl. 60/650

(57) ABSTRACT

Motor-driven compressor-alternator unit including pistons. Each piston has a large diameter portion and a smaller diameter portion extending from the large diameter portion. The large diameter portion slides within a first cylinder and provides a motor function. The smaller diameter portion slides within a second cylinder and provides a compressor function. An arrangement at least one of inactivates the motor function during compressor operation, inactivates the compressor function during motor operation, and activates ambient heat recovery during motor operation. This Abstract is not intended to define the invention disclosed in the specification, nor intended to limit the scope of the invention in any way.

### CROSS-REFERENCE TO RELATED APPLICATIONS

The present application is a continuation of International Application No. PCT/FR02/03667 filed Oct. 25, 2002, the disclosure of which is expressly incorporated by reference herein in its entirety. Moreover, this application claims priority of French Patent Application No. 01/13798 filed Oct. 25, 2001.

### BACKGROUND OF THE INVENTION

1. Field of the Invention

The invention concerns motors and more specifically those powered with additional compressed air injection, featuring a compressed air tank, and which are capable of operating with mono energy or dual-energy, bi- or tri-supply mode, and multiple-energy.

The invention concerns a motor compressor-motor alternator operating especially with compressed air and more specifically using a piston stroke control device that pauses the piston at its top dead center as well as an ambient thermal energy recovery device.

2. Discussion of Background Information

The author has filed many patent applications concerning motorizations as well as their installations, using additional compressed air for completely clean operation within urban or suburban environments:

WO 96/27737 WO 97/00655

WO 97/48884 WO 98/12062 WO 98/15440

WO 98/32963 WO 99/37885 WO 99/37885

In order to implement these inventions, in patent application WO 99/63206 (refer to this patent for further details) the author also referred to a process and motor piston stroke control device allowing the piston to be stopped at its top dead center; a process which is equally described in his patent application WO 99/20881 the contents of which can also be referred to concerning the operation of these mono- or dual-energy motors with bi- or tri-supply modes.

Vehicles equipped with these propulsion systems must be equipped with a compressed air recharging system featuring an on-board compressor driven by an electric motor as described in patent WO 98/12062 (refer to this patent for further details).

In addition, such vehicles must be equipped with an electric starting system to start the motor and an alternator device to recharge the batteries and supply the necessary on-board electricity.

Numerous alternator-starter systems have been installed on vehicles such as the Panhard and Levassor in the 1930s or Isard Glass in 1958 which were equipped with such a device called the “dynastar”. More recently, numerous electric couple modulation control systems are currently being industrialized and electric/thermal hybrid motors exist with electric motor assistance.

In order to obtain good yield and to limit the compression ratio in each cylinder, the high pressure compressors must use several compression stages with, between them, exchangers enabling the compressed air to be cooled, for example 3 or 4-stage piston type compressors featuring 3 or 4 assemblies of cylinders and pistons are thus habitually used in the industry, the first stage performing, for example, the compression of the atmosphere to 8 bar then the second stage passing from 8 to 30 bar, then the third from 30 to 100 bar and the last stage from 100 to 300 bar. The effective volumetric displacement of each of the cylinders tapers off in order to compensate the increase in pressure. Between each compression stage, the air heated by the compression is cooled in the heat exchangers.

In patent No. WO 98/32963 (refer to this patent for further details), the author describes an ambient thermal energy recovery device where the compressed air contained in the storage tank at very high pressure (200 bar, for example) and at ambient temperature (20° C., for example), prior to its final use at a lower pressure (30 bar, for example), is expanded to a pressure near that required at its final use, in a variable volume system, (for example, a piston in a cylinder producing work), this expansion with work cools the compressed air expanded to the pressure close to the working pressure to a very low temperature (−100 degrees, for example). This compressed air is then directed into a heat exchanger with the ambient air allowing it to be heated, and will thus increase its pressure and/or volume, by recovering the thermal energy taken from the surroundings; this device can be made on several expansion stages.

In patent WO 98/15440 (refer to this patent for further details), the author describes a reacceleration device using the kinetic energy of the vehicle to compress the air into a tank with variable volume and constant pressure during braking or decelerations and to reinject this air into the expansion chambers during reaccelerations.

In patent application WO 99/37885 (refer to this patent for further details), the author proposes a solution which enables the quantity of usable and available energy to be increased, characterized by the fact that the compressed air, prior to being introduced into the combustion or expansion chamber, coming from the storage tank either directly or after passing through the heat exchanger(s) of the ambient thermal energy recovery device, and before entering the combustion chamber, is directed into a thermal heater where, by increasing its temperature, its pressure and/or volume increases before being introduced into the motor's combustion and/or expansion chamber, thus again considerably increasing the performance characteristics possibly provided by said motor.

The use of a thermal heater, and notwithstanding the use of a fossil fuel, has the advantage that it is possible to use clean continuous combustion which can be catalyzed or cleaned by all known means in an attempt to obtain minute polluting emissions.

In patent No. WO 99/63206, the author proposes an operating process enabling dual-energy compressed air operation of the motor—in the city and air plus conventional fuel operation on the highway—in the case where the compression inlet chamber has been removed—characterized in that the opening and closing cycle of the exhaust valve which opens at each motor revolution on a part of the piston upstroke is changed during operation to open during the piston upstroke every other turn, and in that, jointly the motor is equipped with an inlet for air and fuel such as gasoline, diesel fuel or other, enabling the introduction of an air-fuel mixture which is drawn in during the piston downstroke then compressed in the expansion chamber which then becomes a combustion chamber, in which the mixture is burned then expanded producing work by pushing back the piston and then pushed back to the exhaust as with a traditional cycle of a 4-stroke engine. In this same patent, the author also proposes a three-mode operating solution characterized in that the motor operates either with compressed air without heating, for example for urban driving with zero pollution, or with compressed air reheated by external combustion in a thermal heater powered by a traditional fuel, for example in suburban traffic with minute pollution, or for highway driving, with thermal with the intake of air and gasoline (or any other fuel) enabling an air-fuel mixture to be introduced which is drawn in during the downstroke of the piston, then compressed in the expansion chamber which then becomes a combustion chamber, in which the mixture is burned then expanded producing work and exhausted into the atmosphere according to the traditional cycle of a four-stroke motor.

The three operating modes described above can be used separately or in combination, regardless of the opening and closing methods of the intake ports and exhaust ducts, the methods and devices for switching from one mode to another, controlled by electronic, electromechanical, mechanical devices or others, the fuels or gases used, without changing the principle of the invention described in said patent. Just as the intake and exhaust valves can advantageously be controlled by electric, pneumatic or hydraulic systems controlled by an electronic computer according to the operating parameters.

The inventor also filed patent No. WO 00/07278 (refer to this patent for further details), concerning a fuelless emergency generator unit based on the technologies described previously.

The multiplication of these devices complicates the manufacture of these mechanical assemblies and makes them expensive.

### SUMMARY OF THE INVENTION

The invention proposes to simplify the mechanical assembly by proposing a motor-driven compressor-alternator unit operating on mono-energy with compressed air or in bi-energy, bi or tri-supply mode and notably featuring a piston stroke control device causing the piston to stop at its top dead center, as well as an ambient thermal energy recovery device.

The motor according to the invention is characterized by an arrangement which, taken together or separately provides, and more specifically provides:

that the pistons have two stages of diameter featuring a large diameter cap sliding in a so-called “working” cylinder to ensure the motor function during expansion followed by the exhaust and of which said cap is extended from a so-called “compression” second stage piston of smaller diameter to ensure the compression function of the compressed air stored in the high pressure tank.

that the second stage pistons are used for the expansion with work function in the ambient thermal energy recovery system.

that commutation and interaction arrangements are placed between the various cylinders rendering the motor function inactive during compressor operation, and/or the compressor function inactive during motor operation, and/or to activate the ambient heat recovery function during motor operation.

that heat exchangers are placed between each compression, and/or thermal energy recovery expansion cylinder in order to cool the compressed air that passes through them, during the compressor function, and/or to reheat it during the ambient thermal energy recovery function.

that the motor flywheel features an arrangement, integral on its periphery, enabling an electronically-controlled electric motor to be made to drive the unit in its compressor function powered by the household power supply system (220V).

that this electric motor is reversible and may be used as a generator or alternator.

According to a variant of the invention, the motor-driven alternator thus described can be used to start the unit in its motor function by producing at least one motor revolution to bring the motor to its compressed air injection position, and/or to occasionally participate in increasing the torque of the motor, or to produce electricity during continuous operation for on-board use, or to act as a retarder by provoking an opposite torque during this production of electricity.

According to a variant of the invention, the motor-driven alternator may be used to recover electrical energy during vehicle decelerations and/or braking,

When using the unit in compression mode, using notably the energy provided by the household electrical supply, and according to another aspect of the invention, the electric motor is characterized in that its rotation speed is variable, operating at high speed when the tank is empty and in that the torque required by the compressor's drive motor is low in order to reach a lower rotation speed matching the shape of the torque curve of the electric motor.

The electric motor installed on the flywheel may employ well-known permanent-magnet motor techniques, said magnets being secured on its rotor (which is the motor flywheel) while electromagnet windings are mounted more or less concentrically, secured radially or axially, on an appropriate housing integral with the block of the motor-driven compressor-alternator unit or employ variable reluctance motors or other devices known to those skilled in the art, without deviating from the principle of the invention.

According to a preferential embodiment, the motor unit is equipped with moving parts (crank rod system) featuring an engine piston movement control system as described in patent WO 99/20881 (refer to this patent for further details), characterized by the fact that the piston is held at its top dead center position for a period of time—thus on a significant angular sector during the rotation—enabling the following operations to be performed at constant volume:

the gas or compressed air transfer operations, piston paused at top dead center;

the starting and combustion operations in the case of traditional motors;

the fuel injection operations in the case of diesel motors;

the exhaust completion, start of inlet operations in all cases of motors and compressors.

To enable the piston to stop at top dead center, a pressure lever device implements piston control, itself controlled by a crank rod system. A system having two articulated arms, one of which has an immobile end, or pivot, and the other being able to move along an axis, is referred to as a pressure lever. When they are aligned, if a force approximately perpendicular to the axis of the two arms is exerted on the articulation between these two arms, the free end moves. This free end is connected to the piston and controls its movements. The top dead center of the piston is reached when the two articulated rods are roughly lined up with one another (at approximately 180°).

The crankshaft is connected to the hinge pin of both arms by a control rod. The position of the various elements in space and their dimensions allow the characteristics of the kinetics of the assembly to be modified. The position of the immobile end determines an angle between the piston's displacement axis and the axis of both arms when they are aligned. The position of the crankshaft determines an angle between the control rod and the axis of the two arms when they are aligned. The variation in the value of these angles, as well as the lengths of the rods and arms, enables the rotation angle of the crankshaft to be determined during which the piston is stopped at top dead center. This corresponds to the duration of the piston pause.

According to a specific embodiment, the entire device (piston and pressure lever) is balanced by extending the lower arm beyond its immobile end, or pivot, by a pressure mirror lever in opposite direction, symmetrical and having inertia identical to which is secured an inertial weight identical and opposite in direction to that of the piston, able to move along an axis parallel to the piston's axis of movement. Inertia refers to the product resulting from the mass multiplied by the distance of its center of gravity at a reference point. In the case of a multiple-cylinder motor, the opposite mass can be a piston operating normally as the piston that it balances.

Preferably, the device according to this invention uses this last arrangement although is characterized in that the axis of the opposed cylinders, and the fixed point of the pressure lever are more or less aligned along the same axis, and characterized in that the axis of the control rod connected to the crankshaft is positioned, on the other hand, not on the common axis of the articulated arms but on the arm itself between the common axis and the fixed point or pivot. Owing to this, the lower arm and its symmetry represent a single arm with the pivot, or fixed point, more or less at its center and two pins at each of its free ends connected to the opposed pistons.

The number of cylinders can vary without deviating from the principle of the invention while, preferably, assemblies having an even number of two opposed cylinders are used and more specifically more than two cylinders, four or six for example, in order to have a number of compression and recovery expansion stages greater than 2.

The diameters of the pistons and the compression and recovery cylinders of the same motor are different in order to obtain decreasing displacements in order to allow compression in several stages of decreasing volume and conversely of increasing volume when they are used in expansion for ambient thermal energy recovery.

During the compressor function, one of the motor pistons and motor expansion cylinders can be used as the first stage of the compressor in order to provide greater output, the compression pistons of the second stages being, by design, smaller in diameter.

Preferably, and due to the fact that the diameters of the compression pistons are different, the diameters of the motor pistons are proportionally different in order to obtain identical motor piston surface areas for better thrust regularity and just as the weight of the pistons shall be identical for a better balancing of the entire unit.

Preferably, the expansion chambers of the motor cylinder(s) are paired with the cylinder and during single-energy operation (air plus additional compressed air), the exhaust orifice is blocked during the upstroke of the piston to allow part of the previously expanded gases be recompressed at a high pressure and temperature as claimed in patent application WO 99/63206.

According to a variant of the invention, the switching and interaction device can become active at deceleration and/or braking time to operate the compressor and store this compressed air in a variable-volume and constant pressure tank for example, then to reinject this compressed air when the vehicle accelerates once again.

Heat exchangers are installed between each compressor cylinder to cool the air between each stage during compression and to heat the air during expansion in ambient thermal energy recovery mode. These heat exchangers may consist of finned tubes or radiators.

The heat exchangers can be air-air or liquid air exchangers or any other device or gas producing the desired effect.

Preferably, the motor-driven compressor-alternator according to the invention is equipped with an ambient thermal energy recovery system such as described by the author in patent WO 98/32963 wherein the compressed air contained in the storage tank at very high pressure, 200 bar for example, and at ambient temperature, 20 degrees for example, prior to its final use at a lower pressure, 30 bar for example, is expanded to a pressure near that required for its final use, in a variable-volume system, for example a piston in a cylinder, producing work which can be recovered and used by any known means, whether mechanical, electrical, hydraulic or the like. This expansion with work cools, at very low temperature, −100° C. for example, the compressed air expanded to a pressure near that of its service pressure. This compressed air, expanded to its service pressure, and at very low temperature, is then sent into an exchanger with the ambient air, is heated to a temperature close to ambient temperature, and its pressure and/or volume thus increases recovering heat energy taken from the atmosphere. This operation, which can be repeated several times on several stages, the ambient thermal energy recovery system according to the invention is characterized in that the cylinders and compression pistons are used to execute these successive expansions and in that the heat exchangers used to cool the air during compressor use also are used to heat the previously expanded air, and also characterized in that branch connection means are designed to successively use the various stages of the recovery cylinders, the volumes of which are increasingly large, as the pressure decreases in the storage tank in order to allow for adapted expansions.

Preferably again, the motor-driven compressor-alternator according to the invention is equipped with a thermal heating system as described by the author in patent WO/99/37885, where he proposes a solution which increases the amount of usable and available energy, characterized by the fact that the compressed air, before entering the combustion and/or expansion chamber, coming from the storage tank is, either directly or after going through the heat exchanger of the ambient thermal energy recovery device, and before entering the expansion chamber, channeled into a thermal heater, where, by an increase in temperature, it will again increase in pressure and/or volume before entering the combustion and/or expansion chamber, thus again increasing considerably the possible performance characteristics of the motor.

The use of a thermal heater has the advantage that it is possible to use clean continuous combustion which can be catalyzed or depolluted by all known means in order to obtain minute polluting emissions.

The thermal heater can use a fossil fuel such as gasoline or LPG, natural gas for vehicles, thus enabling bi-energy operation with external combustion in which a burner is used to cause a temperature increase.

According to a variant of the invention, the heater advantageously uses thermochemical processes based on absorption and desorption processes, such as those used and described for example in patents EP 0 307297 A1 and EP 0 382586 B1, these processes using the transformation by evaporation of a fluid, liquid ammonia for example, into gas reacting with salts such as calcium chloride, manganese chloride or others. The system operates as a thermal battery where, in a first phase, the evaporation of the ammonia reserve contained in an evaporator produces cold on the one hand and a chemical reaction, on the other hand, in the reactor containing salts which release heat; when the ammonia reserve is exhausted, the system is rechargeable in a second phase by the input-of heat in the reactor which reverses the reaction whereby the ammonia gas separates from the chloride, and returns to the liquid state by condensation.

The application according to the invention is characterized in that the thermochemical heater thus described uses the heat produced during phase 1 to increase the pressure and/or the volume of the compressed air coming from the high pressure storage tank, before entering the expansion chamber of the engine cylinder.

During phase 2, the system is regenerated by the influx of heat released by the exhaust of the various stages of the compressor during compressor operation in order to recharge the main high pressure storage tank.

According to a variant of the invention, the motor-driven compressor-alternator unit is equipped with a burner type thermal heater, or the like, and a thermochemical heater of the type previously described which can be used jointly or successively during phase 1 of the thermochemical heater wherein the burner type thermal heater will enable the thermochemical heater to be regenerated (phase 2) when the latter is empty by heating its reactor while the unit is operating using the burner type heater.

According to another embodiment of the invention, the motor-driven compressor-alternator unit equipped with a thermal heater operates in a standalone manner, without using the high pressure compressed air contained in the storage tank, by taking the compressed air supplied by one or more compression stages depending on the service pressures desired; this compressed air is then reheated in the reheating system where its temperature increases, thus increasing its volume and/or pressure, then reinjected into the expansion chambers of the motor cylinders to allow the unit to operate by expanding and by producing the power stroke.

According to another variant of embodiment above, and when the unit functions in a standalone manner, the exhaust air from the expansion cylinders is directed toward the thermal heater either directly, or via one or more compression stages where its temperature increases thereby increasing its pressure and/or volume, then it is reinjected into the expansion chambers of the expansion cylinders to allow the unit to function by producing the power stroke. On the exhaust circuit, and before the thermal heater, a relief valve allows said pressure to be controlled and to release excess air into the atmosphere.

According to a variant of the embodiment above, part of the air of the compression can channeled and/or other stages of the compressor are used to recharge the main tank while the motor operates in a standalone manner as described above.

The motor-driven compressor-alternator unit thus equipped operates in dual-energy mode using, for city driving for example, zero pollution operation with the compressed air contained in the high pressure storage tank, and for highway driving, still for the sake of the example in standalone operation with its thermal heater powered by a fossil fuel, while resupplying, by one or more of its compression stages, the high pressure storage tank.

The motor-driven compressor-alternator unit according to the invention also operates with three energy sources, for city use for example, using the zero pollution configuration with the compressed air contained in the high pressure storage tank, and the thermochemical heater, then for highway use with its thermal heater supplied by fossil fuel while resupplying the high pressure storage tank by one or more of its compression stages, and by regenerating the thermochemical heater by inputting heat to the reactor to cause the desorption of the gaseous ammonia which will recondense in the evaporator.

The motor-driven compressor-alternator unit according to the invention also operates with four energy sources, when the electric motor equipping its flywheel is switched either to perform a maneuver requiring little energy, or to occasionally increase the power delivered for example, to go up a hill, or to pass, or to obtain better start boost.

The motor-driven compressor-alternator unit according to the invention described above operates with four sources of energy which, when used notably on vehicles, and according to the desired performance characteristics or the requirements, can be used together or separately.

The energy from the compressed air contained in the high pressure storage tank is the main source and is used especially for perfectly clean vehicle operation in an urban environment.

The thermochemical energy is used to increase the performance characteristics and autonomy of the vehicle while operating strictly with zero pollution.

The fossil fuel of the burner heater which is used:

to increase the performance characteristics and autonomy of the vehicle in operation with compressed air injection;

for vehicle highway driving, or when the storage tank is empty;

to fill the tank while allowing the vehicle to operate;

to regenerate the thermochemical heater when the latter is also empty.

The electrical energy which is used:

namely to drive the compressor when recharging the compressed air tank while the vehicle is connected to the household 220 V power supply;

to start the unit powered by the vehicle battery;

to occasionally increase the motor torque as required;

to brake the vehicle during decelerations and braking.

Those skilled in the art will select the switching mode of the various systems according to requirements and characteristics and will program the various implementation parameters, for example to operate the burner type thermal heater at a given vehicle speed, such as 60 km/h for example.

The piston stroke control device according to the invention is characterized in that the axis of the opposed cylinders and the fixed point of the pressure lever are more or less aligned on the same axis and characterized in that the axis of the control rod connected to the crankshaft is positioned not on the common axis of the articulated arms but on the arm itself between the common axis and the fixed point or pivot. For this reason, the lower arm and its symmetry represent a single link oscillating on the pivot or fixed point, positioned more or less at its center, and featuring two pins at each of its free ends connected to the opposed pistons by connecting rods.

The piston stroke control device according to the invention can advantageously be applied to conventional 2-stroke, 4-stroke, diesel or applied ignition internal combustion motors.

While it is a great advantage to be able to have the piston pause at its top dead center, all of these devices can also be used with a traditional crankshaft device without changing the invention described.

The motor-driven compressor-alternator unit according to the invention can be used as an auxiliary engine on all land, maritime, rail, and aeronautic vehicles.

The motor-driven compressor-alternator unit according to the invention can also be used advantageously in emergency generator sets as described by the author in WO 00/07278 as well as in numerous household cogeneration applications producing electricity, heating and air conditioning.

The invention also provides for a motor-driven compressor-alternator unit comprising pistons. Each piston has a large diameter portion and a smaller diameter portion extending from the large diameter portion. The large diameter portion slides within a first cylinder and provide a motor function during expansion followed by exhaust. The smaller diameter portion slides within a second cylinder and provides a compressor function. An arrangement at least one of inactivates the motor function during compressor operation, inactivates the compressor function during motor operation, and activates ambient heat recovery during motor operation.

The unit may operate in one of mono-energy with compressed air, dual-energy, bi-mode and tri-mode. The smaller diameter portion may function as at least one of a compression thermal energy recovery piston and an ambient thermal energy recovery piston. An expansion function of the smaller diameter portion may provide ambient thermal energy recovery. The arrangement may comprise a plurality of valves which control air flow between the first and second cylinders.

The unit may further comprise a plurality of heat exchangers arranged to cool an air flow during a compression stage and arranged to heat the air flow during an ambient thermal energy recovery stage. The smaller diameter portion of one of the pistons may comprise a different diameter than the smaller diameter portion of another of the pistons. During compressor operation, the pistons may be structured and arranged to compress air in several decreasing volume stages. The large diameter portion of one of the pistons may comprise a different diameter than the large diameter portion of another of the pistons. The one of the pistons and the other of the pistons may comprise identical expansion piston surface areas. The one of the pistons and the other of the pistons may comprise identical weights so as to provide a correct balancing of the reciprocating masses.

The unit may further comprise a control system that controls top dead center of the pistons. The control system may comprise a first pivotally mounted lever arm and two second arms, each second arm being movably coupled to the first pivotally mounted lever arm and one of the pistons. The first pivotally mounted lever arm may comprise a pivot axis which more or less centrally disposed and wherein each second arm is movably coupled to the first pivotally mounted lever arm via a pin. The pistons may comprise opposed pistons which are movably mounted about a common axis. The pivot axis may comprise a fixed axis which is roughly aligned with the common axis.

The unit may further comprise a control rod movably coupled to the first pivotally mounted lever arm and a crankshaft. The unit may further comprise a pin movably connecting the control rod to the first pivotally mounted lever arm, wherein the pin is arranged between the pivot axis and a connection between the first pivotally mounted lever arm and one of the second arms. The unit may further comprise a motor flywheel adapted to be driven by an electric motor. The unit may further comprise a motor flywheel adapted to be driven by an electronically controlled electric motor. The unit may further comprise a motor flywheel adapted to be driven by an electric motor powered by a household electrical power system. The unit may further comprise a system for controlling a rotation speed of the unit via an electric motor, whereby the unit can be operated at high speeds during filling of a high pressure storage tank coupled to the unit and at slower speeds when the high pressure storage tank is filled.

The unit may be adapted to be driven by an electric motor which can produce electricity during motor operation, whereby the electricity can be used for recharging a battery. The electric motor may comprise an alternator which is structured and arranged to rotate at least one revolution so as to start the motor operation of the unit. The alternator and electric motor may comprise a motor driven alternator unit which is adapted to occasionally participate in increasing motor torque. The motor driven alternator unit may be adapted to function as a speed reducer and is capable of recovering electrical energy during at least one of vehicle deceleration and vehicle braking.

The unit may further comprise a storage tank which receives compressed air from the pistons and which supplies compressed air to the pistons. The unit may further comprise an ambient thermal energy recovery device and a buffer tank coupled to the unit. The unit may further comprise a thermal heater structured and arranged to heat compressed air. The thermal heater may comprise a burner which uses a fossil fuel, whereby the thermal unit is adapted to at least one of increase a volume of the compressed air passing therethrough and increasing a pressure of the compressed air passing therethrough. The thermal heater may use a solid-gas reaction type thermochemical process based on transformation by evaporation of a reagent fluid contained in an evaporator. The thermal heater may use liquid ammonia in a gas which reacts with a solid reagent contained in a reactor to produce heat. The solid reagent may comprise salts. The salts may comprise one of calcium, manganese, and barium chlorides. The heat that is required to condense the reagent fluid may be provided during compressor operation. The unit may further comprise an electric heating element which assists in generating the heat. The thermal heater may comprise a burner heating system which uses energy from a fossil fuel and a thermochemical heating device. The burner heating system may be structured and arranged to regenerate the thermochemical heating device by providing heat required by a reactor to cause a desorption of gaseous ammonia which recondenses in an evaporator, and which continues heating of compressed air passing through a finned pipe of the thermal heater.

The unit may be adapted to function in a standalone manner and without using a storage tank for storing high pressure compressed air. The unit may operate with compressed air supplied by one or more compression stages of the pistons, whereby the compressed air is reheated with a heating system which increases at least one of a volume and a pressure of the compressed air. The unit may operate by reinjecting the compressed air into each expansion chamber of each first cylinder, whereby expansion of the compressed air in the first cylinders produces a power stroke.

The unit may further comprise a thermal heater which receives exhaust air from the first cylinders one of directly and via one or more compression stages, whereby the exhaust air is subjected to a temperature increase. The unit may further comprise a safety valve arranged on an exhaust circuit of the unit, whereby the safety valve controls an air pressure and releases excess air into an atmosphere. The unit may further comprise a thermal heater and a high pressure compressed air storage tank, whereby, before being introduced into the thermal heater, the unit is adapted to supply compressed air generated during compressor operation to the high pressure compressed air storage tank. The unit may be adapted to operate, at low speeds, with compressed air supplied from a high pressure storage tank, whereby the unit generates zero pollution. The unit may be adapted to operate, at high speeds, with compressed air supplied from a high pressure storage tank and heated with a thermal heater which uses energy generated from a fossil fuel. The unit may be adapted to operate with three energy sources which comprise compressed air from a high pressure storage tank, compressed air which is heated by a thermochemical heater, and compressed air which is heated with a thermochemical heater which comprises a reactor that causes desorption of gaseous ammonia and an evaporator which recondenses the gaseous ammonia. The unit may be adapted to operate with four energy sources.

The unit may be adapted to one of produce electricity for household and provide emergency power. The unit may be adapted to provide emergency power and is capable of being switched on automatically, whereby, when the unit is switched on automatically, compressed air contained in a storage tank drives the unit.

The invention also provides for a combination of the unit described above and a 2-stroke engine, or the unit and a 4-stroke engine, or the unit and a diesel engine, or the unit and a compressor driven independently of the unit.

The unit may further comprise a crank lever system coupled to the pistons.

The invention also provides for a motor-driven compressor-alternator unit comprising two pistons. Each piston has a large diameter portion and a smaller diameter portion extending from the large diameter portion. Each large diameter portion slides within a first cylinder. Each smaller diameter portion slides within a second cylinder. Levers connect the two pistons to a crankshaft. First valves allow the unit to operate as a compressor and second valves allow the unit to operate as a motor.

The unit may further comprise a system which provides for ambient heat recovery during motor operation.

The invention also provides for a motor-driven compressor-alternator unit comprising two pistons. Each piston has a large diameter portion and a smaller diameter portion extending from the large diameter portion. Each large diameter portion slides within a first cylinder. Each smaller diameter portion slides within a second cylinder. Levers connect the two pistons to a crankshaft. First valves allow the unit to operate as a compressor and second valves allow the unit to operate as a motor. During motor operation, the first valves are closed, and during compressor operation, the first valves are allowed to operate.

The unit may further comprise at least one pipe for supplying compressed air from one of the first valves associated with one of the two pistons to another of the first valves associated with another of the two pistons.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic cross-sectional representation of the moving parts of the motor-driven compressor-alternator unit at its bottom dead center;

FIG. 2 represents a cross-sectional view of the same moving parts at its top dead center;

FIG. 3 is a schematic cross-sectional representation at bottom dead center, of a motor-driven compressor-alternator unit according to the invention equipped with the mobile parts shown in FIGS. 1 and 2 during motor operation at its bottom dead center;

FIG. 4 represents this same unit during motor operation, at top dead center.

FIG. 5 represents this same unit in air compressor operation;

FIG. 6 is a schematic representation, during compressor operation, of the unit according to the invention equipped with a device enabling operation either in compressor mode or with ambient thermal energy recovery;

FIGS. 7, 8, and 9 represent the same unit according to the invention during motor operation with the use of an ambient thermal energy recovery device;

FIG. 10 is a schematic representation of the motor-driven compressor-alternator unit and equipped according to the invention with a thermal heating device;

FIG. 11 is a schematic representation of a burner thermal heating device capable of operating with a fossil fuel;

FIG. 12 is a schematic representation of the operating principle of a thermochemical reactor heater applied to the invention;

FIG. 13 is a schematic representation of a thermal heater combined with a burner and chemical reactor;

FIG. 14 is a schematic representation at top dead center of the motor-driven compressor-alternator unit according to the invention equipped with a thermal heater and designed for standalone operation;

FIG. 15 represents the same motor at bottom dead center;

FIG. 16 represents the same motor-driven compressor-alternator unit equipped to recharge the storage tank during operation in motor mode; and

FIG. 17 is a schematic representation of the motor-driven compressor-alternator unit according to the invention with its motor flywheel equipped to make an electric compressor drive motor.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

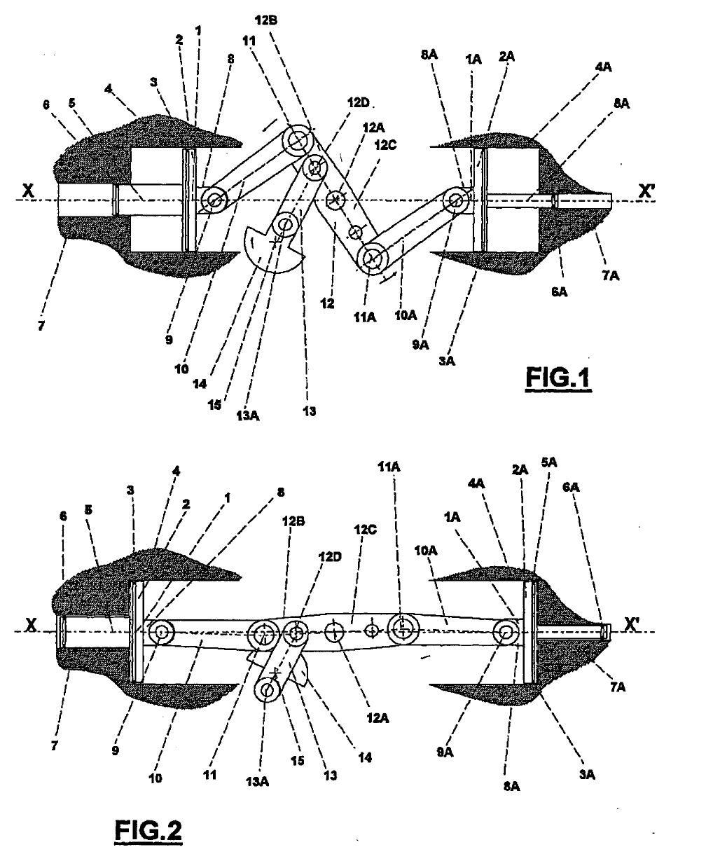

FIGS. 1 and 2 are schematic cross-sectional representations of the architecture of the moving parts of the unit according to the invention featuring two pistons and opposed cylinders roughly along the same axis XX′ where the two-stage pistons 1 and 1A can be seen, each featuring a first motor stage forming a cap of large diameter 2 and 2A equipped with compression rings 3 and 3A and sliding in their working or expansion cylinder 4 and 4A, and a second concentric compression stage 5 and 5A, utilizing a sort of shaft of smaller diameter, also equipped with compression rings 6 and 6A, and sliding in the compression cylinders 7 and 7A, each piston also featuring bosses 8 and 8A enabling them to be connected by a pin, referred to as a piston pin, 9 and 9A, to the rod-crank system by connecting rods 10 and 10A, themselves connected by a common pin 11 and 11A to the two free ends of a swinging link 12 mounted approximately at its center and on a fixed pin 12A, located approximately on the axis of the cylinders X,X′; the fixed pin 12A thus divides the arm 12 into two half-arms 12B and 12C. On one of the two half-arms here, 12B is attached by a pin 12D, a control rod 13 connected to the crankpin 13A of a crankshaft 14 turning on its pin 15. When the crankshaft rotates (in the direction of the arrow), the control rod 13 exerts a force on pin 12D, causing the swinging link 12 to move, thus allowing pistons 1 and 1A to move along the axis of the cylinders 4, 4A, 6, 6A, or along axis X,X′ from bottom dead center (FIG. 1) to top dead center (FIG. 2), and transmits the forces exerted on pistons 1 and 1A in return to the crankshaft 14, during the power stroke from top dead center to bottom dead center thus causing said crankshaft to rotate. When the pistons are at their top dead center point (FIG. 2), the connecting rods 10 and 10A and the swinging link 12 are aligned along axis XX′. In this position, the distance between the crankpin 13A of the crankshaft and axis XX′ is nearly identical during part of the crankshaft rotation thus controlling the stroke of the pistons which remain stopped at their top dead center for a significant period of time.

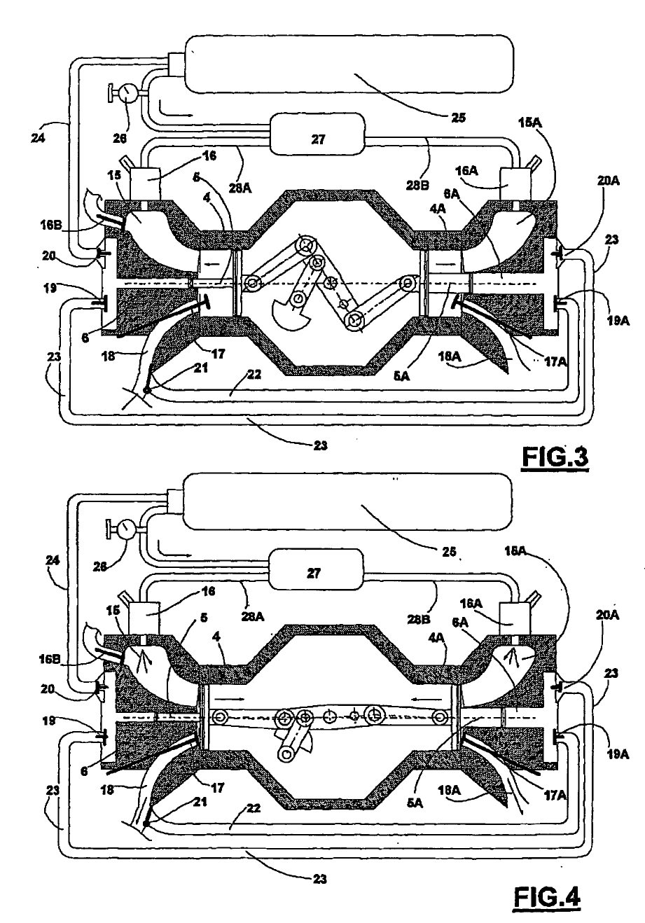

FIGS. 3 and 4 show a cross-sectional schematic representation of the motor-driven compressor-alternator according to the invention where the same moving parts can be seen in FIGS. 1 and 2, and in which each working cylinder 4 and 4A includes an expansion chamber 15 and 15A itself equipped with an air injector 16 and 16A as well as an exhaust valve 17 and 17A and an exhaust pipe 18 and 18A.

Each compression cylinder 6 and 6A includes intake valves 19 and 19A and exhaust valves 20 and 20A. The exhaust pipe 18 of expansion cylinder 4 includes a two-way valve 21 which allows, depending on whether it is open or closed, to direct the exhaust flow either to the atmosphere or through pipe 22 to the inlet 19A of the compression cylinder 6A while the exhaust valve 20A of cylinder 6A is connected by a pipe 23 to the compression cylinder inlet valve 19 of compression cylinder 6 and while the exhaust valve 20 of said cylinder, is connected by a pipe 24, to the high pressure storage tank 25 which supplies the motor injectors 16, 16A through a regulator 26 and a buffer tank 27 at the service pressure (for example, 30 bar).

During operation in motor mode, FIGS. 3 and 4, the inlet and exhaust valves 19, 19A, 20, 20A, of the compression cylinders are maintained closed enabling the compression cylinders 6 and 6A to idle and the valve 21 blocks the pipe 22 connecting the exhaust of the working cylinder 4 to the inlet valve 19A of the compression cylinder 6A when at top dead center, FIG. 4, and during the time when the piston remains in its top dead center position, the air injectors 16 and 16A are actuated and pressurize the expansion chambers 15 and 15A, then the pressure applied on the large cap 2 and 2A of pistons 1 and 1A pushes the pistons toward their bottom dead center point, FIG. 3, by transmitting the forces applied to the crankshaft 14 and turning the motor to produce work, the exhaust valves 17 and 17A are thus open to enable the expanded air to be released into the atmosphere during the upstroke of the pistons.

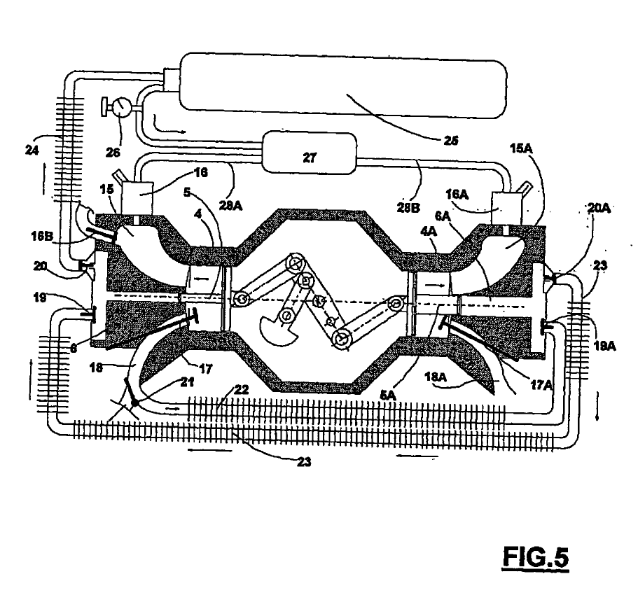

During compressor operation, FIG. 5, the unit is driven by an electric motor or other device (not shown in this figure), the inlet valves 19 and 19A and exhaust valves 20 and 20A of the compression cylinders are released to allow them to operate, and the flap 21 blocks the release of exhaust air 18 to the atmosphere, and directs it through the finned pipe 22 to the inlet valve 19A of the compression cylinder 6A; the injectors 16 and 16A are no longer actuated thus authorizing the working cylinder 5A to idle while an inlet valve 16B positioned in the expansion chamber 15 of the cylinder 4 is also released to authorize its operation. When the pistons perform their downstroke, the intake valve 16B is open and allows the working cylinder which in this operating configuration is the first compressor stage, to fill with air at atmospheric pressure; during the upstroke of the pistons, valve 16B is automatically closed, and the exhaust valve 17 is opened; the air is thus compressed through the finned pipe 22 toward the inlet valve 19A of the compression cylinder 6A, while the compression piston 5A discharges the compressed air by the finned pipe 23 to the inlet 19 of the compression cylinder 6, and while the compression piston 5 discharges the high pressure compressed air through the exhaust valve 20 and the finned pipe 24 toward the storage tank 25.

Between each compression stage, the compressed air is cooled in the finned tubes acting as an air-air exchanger to obtain optimum yield.

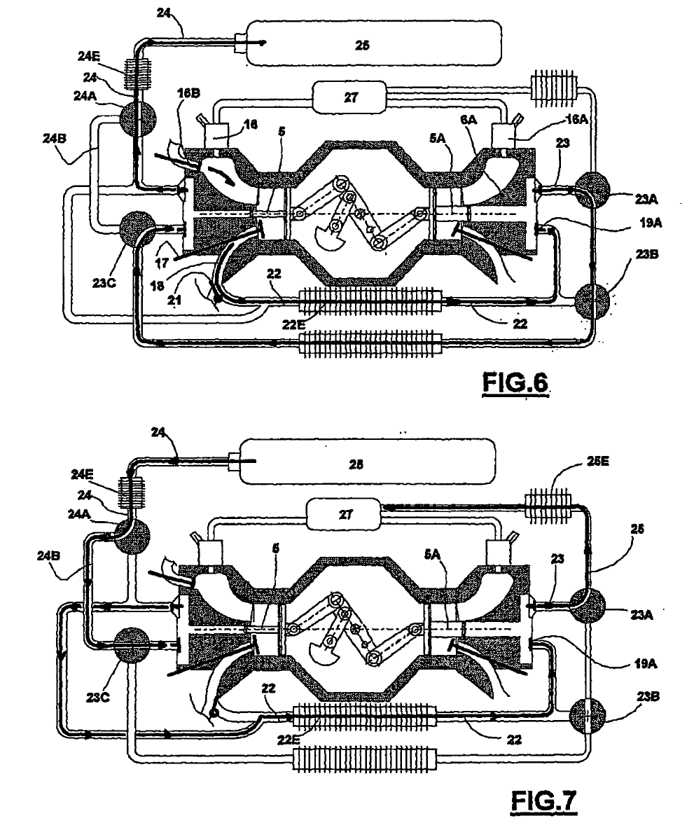

FIGS. 6, 7, 8 and 9 represent the unit according to the invention equipped with air-air heat exchangers (or radiators) and arrangements and devices to allow the use of the main elements making up the compression cylinders for compressor operation, on the one hand, and for the ambient thermal energy recovery operation, on the other hand. Here, the unit is represented with its heat exchangers or air-air radiators.

During compressor mode operation, in FIG. 6, the unit is driven by an electric motor or the like (not shown in this figure), the inlet and exhaust valves of the compression cylinders are released in a position to allow them to operate, and the flap 21 prevents exhaust air 18 from being released to the atmosphere, and directs it through the finned pipe 22 and the radiator 22E to the inlet valve 19A of the compression cylinder 6A; the injectors 16 and 16A are no longer actuated thus authorizing the working cylinder 5A to idle while an inlet valve 16B placed in the expansion chamber 15 of working cylinder 4 is also released to authorize its operation. When the pistons undertake their downstroke, the inlet valve 16B authorizes the working cylinder, which in this operating mode is the first stage of the compressor, to fill with air at atmospheric pressure; during the upstroke of the pistons, valve 16B is automatically closed and the exhaust valve 17 is opened, the air is thus compressed, through the pipe 22 and the radiator 22E where it will cool down, towards the inlet valve 19A of the compression cylinder 6A, while the compression piston 5A discharges the compressed air in its cylinder towards the inlet valve 19 of compression cylinder 6, through pipe 23, and through the radiator 23E where it will cool down. The by-pass valves 23A, 23B, and 23C, are positioned to obtain this routing. During this time, the compression piston 5 discharges high-pressure compressed air through exhaust valve 20, pipe 24, by-pass valve 24A and radiator 24E, towards storage tank 25.

Between each compression stage, the air is thus cooled in the radiators to obtain the best yield.

FIG. 7 represents the same motor unit during motor mode operation with the ambient thermal energy recovery mode where it can be seen that the high pressure air contained in tank 25 is directed through pipe 24, radiator 24E, by-pass valve 24A and the by-pass line 24B, and by-pass valve 23C to the inlet valve 19 of cylinder 6 where it will produce work by pushing the piston 5, and by expanding, to then be discharged during the piston upstroke through the exhaust valve 20, by-pass line 22C then through the pipe 22 and the radiator 22E where it will be reheated, thus increasing the pressure and/or volume, toward the inlet valve 19A of cylinder 6A where it will again produce work, during the downstroke of the pistons, by pushing the piston 5A and by cooling down once again, to then be discharged during the upstroke of the pistons at a still lower pressure through pipe 23, by-pass valve 23A, pipe 25 and radiator 25E where it will again increase in volume and/or pressure by heating up, toward the service pressure buffer tank to supply the working cylinders 4 and 4A. During these cycles, the air in the storage tank underwent two expansion phases with work and two reheating phases in radiators 22E and 25E where, during each heating phase, it increased in volume and/or pressure by recovering thermal energy in the atmosphere.

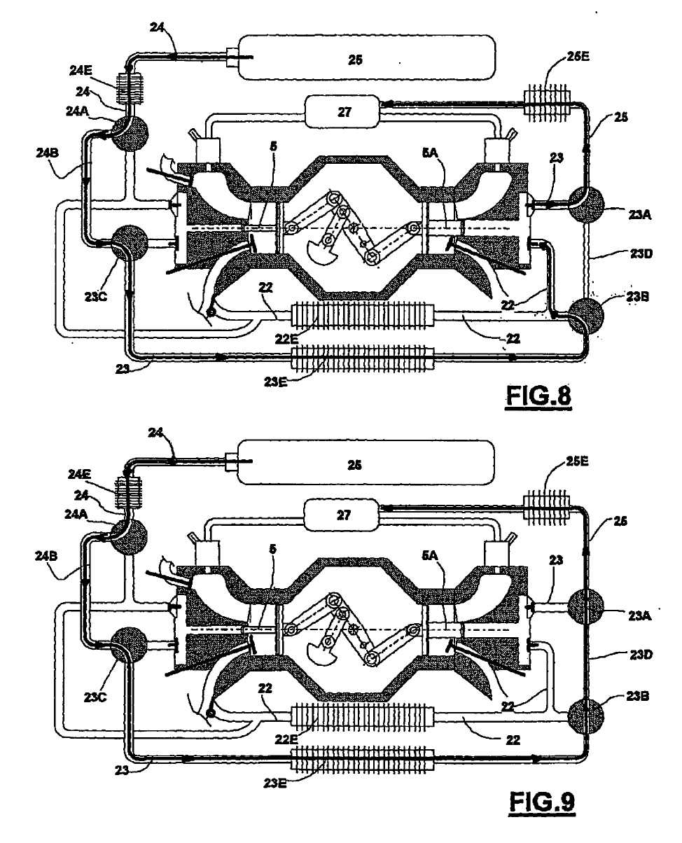

As the pressure in the storage tank 25 has decreased, FIG. 8, pressure expansion in the first of the second stage cylinders, in this instance 5, of small displacement, can no longer be performed, and the air coming from the storage tank is thus directed by the configuration of the by-pass valves to the recovery cylinder 6A of larger volume, through the radiator 24E, the by-pass valve 24A, the pipe 24B, by-pass valve 23C, pipe 23, radiator 23E, valve 23B, pipe 22 and the inlet valve 19A where it will expand producing work by pushing back the piston 5A and by cooling down, to then be discharged by the exhaust valve 20A, pipe 23, by-pass valve 23A, pipe 25 and the radiator 25E where it will again increase in volume and/or pressure by heating up, toward the service pressure buffer 27 to supply the working cylinders 4 and 4A.

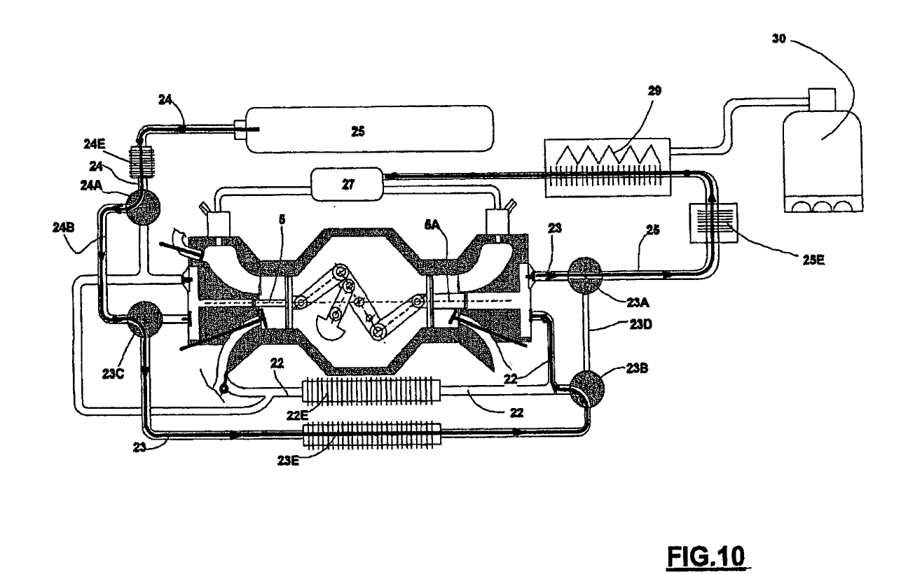

As the pressure in the storage tank 25 has dropped again, FIG. 9, the two recovery cylinders can no longer be used and are by-passed; to do this, the by-pass valves are configured so that the compressed air contained in the storage tank is directed to the buffer tank 27 according to the following circuit: pipe 24, radiator 24E, valve 24A, pipe 24B, valve 23C pipe 23 radiator 23E, valve 23B, by-pass pipe 23D, valve 23A, pipe 25 and radiator 25E.

It should be noted that the passage of the compressed air, which drops slightly in temperature when leaving the storage tank, into the radiators will nevertheless allow it to be maintained close to ambient temperature.

FIG. 10 is a schematic representation of the motor-driven compressor-alternator unit and equipped according to the invention with a thermal heating device 29 placed on the pipe 25 after the radiator 25E where it can be seen that the air coming from the high pressure storage tank 25, and after having passed through the ambient thermal energy recovery device and its radiators 24E 23E 25E, its temperature will increase considerably and will increase in pressure and/or volume in a thermal heater before being introduced into the final use buffer tank 27.

FIG. 11 is a schematic representation of a burner type thermal heater device which can operate with fossil fuel such as gasoline or diesel fuel, or even LPG or natural gas for vehicles, represented here by a gas cylinder 30. The compressed air coming from the storage tank is fed into the heater 29 by a pipe 25, whose diameter increases in the hearth of the heater 31 in order to slow down the flow of compressed air in order to obtain a longer heating time and is equipped with numerous fins 32 to provide good heat exchange, then the pipe 25 returns to its diameter upon leaving the hearth, to return to the final use buffer tank after having increased in pressure and/or volume. A burner 33 is positioned underneath the finned pipe; a device 34 which controls the inlet of the gas/air mix required for combustion 34A allows the heating to be controlled. The combustion air is discharged by the exhaust 35 which features a catalyst 35B in order to ensure minute polluting emissions.

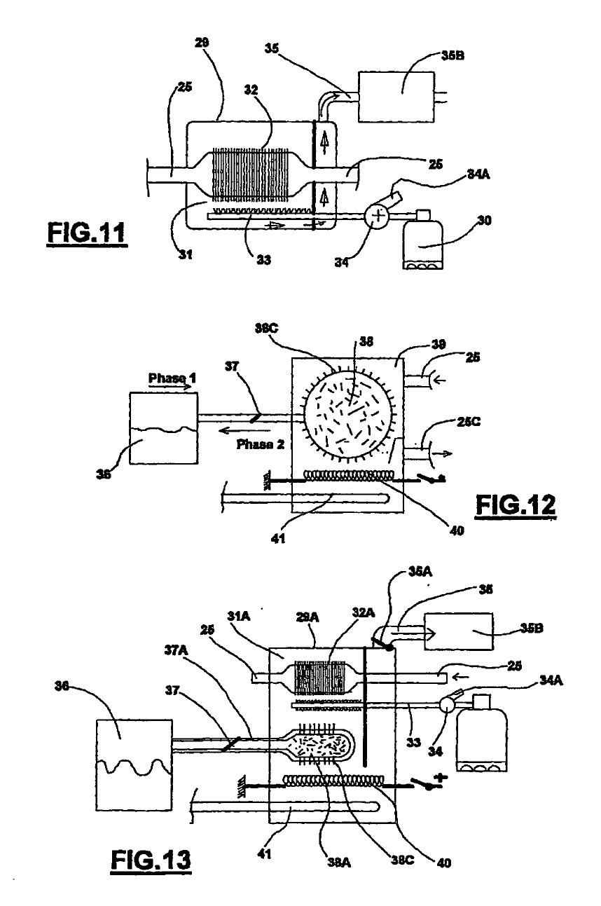

FIG. 12 is a schematic representation of the operating principle of a thermochemical reactor applied to the invention, where the two operating phases can be seen. The device utilizes an evaporator containing liquid ammonia 36; when the control valve 37 is opened, the liquid ammonia evaporates and the gaseous ammonia is fixed by the solid salts contained in the reactor 38 such as calcium chloride, resulting in the production of heat. The reactor is equipped with fins 38C to obtain better heat exchange in order to supply a maximum amount of heat to the compressed air contained in the storage tank 39 entering via pipe 25 before increasing in pressure and/or volume then discharged by pipe 25C to the final use buffer tank. At the end of the reaction, heat input, recovered by the inter-stage exchangers of the compressor and transported by heat pipe 41, during the filling of the compressed air storage tank, the motor-driven compressor-alternator unit being in compressor mode, possibly assisted by an electric heating element 40, causes the desorption of the gaseous ammonia which then recondenses into the evaporator in order to restart a new cycle.

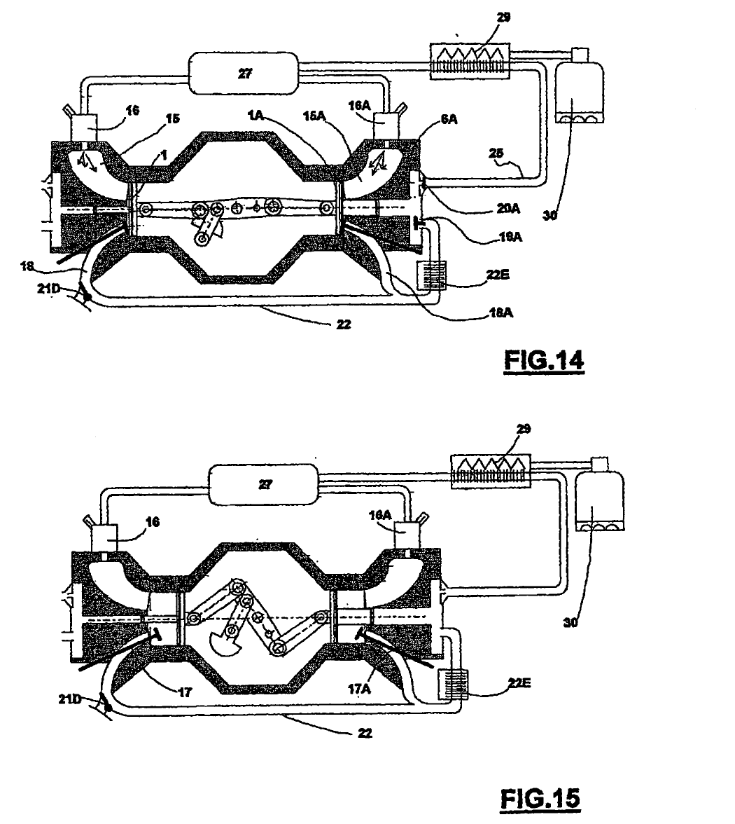

FIG. 13 is a schematic representation, according to the invention, of a thermal heater featuring a burner supplied by fossil fuel combined with a thermochemical reactor where it can be seen that the heater 29A wherein the compressed air coming from the storage tank enters the heater by a pipe 25 into the hearth of the heater 31A, the diameter of the pipe 25 increases in order to slow down the flow to provide a longer heating time and is equipped with numerous fins 32A to provide good heat exchange, then the pipe 25 returns to its diameter upon leaving the hearth, to return to the final use buffer tank after having increased in pressure and/or volume, a burner 33 is positioned underneath the finned pipe; a device 34 which controls the inlet of the gas/air mix required for combustion 34A allows the heating to be controlled. The combustion is discharged by the exhaust 35, which features a catalyzer 35B in order to ensure minute polluting emissions. A reactor 38A equipped with its exchange fins 38C containing salts such as calcium chlorides is located in the hearth 31A, and near the burner, and is connected to an evaporator 36 containing liquid ammonia, located outside the hearth 31 of the heater 29. An electrical heating element 40 is placed underneath the reactor 38A.

When the vehicle operates in zero pollution mode, powered by the compressed air contained in the storage tank, the control valve 37 is opened and the liquid ammonia contained in the evaporator 36 evaporates, the gaseous ammonia is thus fixed by the solid salts such as calcium chlorides, contained in the reactor 38, leading to the production of heat which is transferred to the compressed air contained in the pipe 25 by heat exchange through the fins 32A and 38A of the reactor and said pipe to allow the increase in pressure and/or volume of the compressed air that passes through it. When the chemical reaction is completed, it is thus possible to light the burner 41 which allows the thermochemical device to be regenerated, on the one hand, by inputting the heat required by the reactor to initiate the desorption of the gaseous ammonia which will recondense in the evaporator, and to continue the heating process of the compressed air contained in the pipe 25, on the other hand.

FIG. 14 represents a motor-driven compressor-alternator unit equipped with one of the equipment configurations possible for standalone operation without a high pressure compressed air tank, where it can be seen that the unit according to the invention, equipped with its heater 29 powered by fossil fuel contained in a gas cylinder 30 and in which the exhaust ports 18 and 18A are connected by the pipe 22 to the inlet valve 19A of the compression cylinder 6A while the exhaust valve 20A of said compression cylinder 6A is connected to the buffer tank 27 through the pipe 25 and the thermal heater 29.

When the piston is at top dead center, as in FIG. 14, the air injectors are controlled and the pressure increases in the expansion chambers 15 and 15A, the pistons 1 and 1A are thus pushed toward their bottom dead center performing the power stroke, during the upstroke of the pistons, in FIG. 15, the exhaust valves 17 and 17A are open and the expanded air is pushed back and recompressed toward the compression cylinder 6A through the exhausts 18, the pipe 22, the radiator 22E and the inlet valve of the compression cylinder 6A, the air then enters the cylinder 6A as soon as the pistons reach top dead center while the air compressed during the preceding cycle in the compression cylinder 6A is discharged toward the heater 29 where it will increase in pressure and/or volume to be introduced into the buffer tank 27 in order to supply the injectors 16 and 16A. On the exhaust circuit, a safety valve 21D allows the inlet pressure to be controlled in the compression cylinder 6A and to allow excess compressed air to be released into the atmosphere.

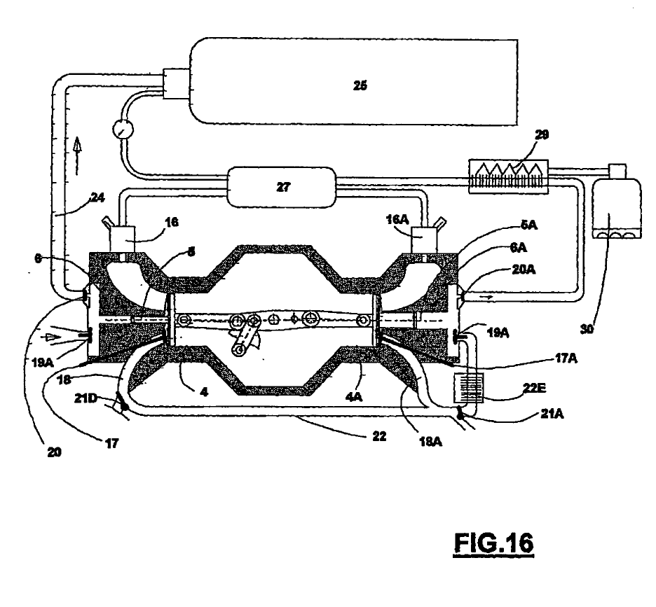

FIG. 16 represents the same motor-driven compressor-alternator unit, equipped to allow the high pressure compressed air storage tank 25 to be filled during standalone operation depicted in FIGS. 14 and 15, showing the inlet valve of the compression cylinder 6 supplied with ambient air, and the exhaust valve 20 of the same compression cylinder with its pipe 24 connecting it to the high pressure storage tank 25. When the motor is operating in standalone mode where the energy is supplied by the gas contained in the cylinder 30, during its downstroke the compression piston draws in ambient air and compresses it during its upstroke through the exhaust valve and the pipe 24 into the storage tank 25. The motor-driven compressor-alternator unit can thus operate on mono-energy with compressed air; the high pressure compressed air contained in the tank 25 expands and is directed at the final service pressure into the buffer tank 27 to supply the injectors 16 and 16A which, when they open at top dead center, will pressurize the expansion chambers 15 and 15A to push back pistons 1 and 1A by expanding and provide power stroke. During the piston upstroke, the exhaust valves 17 and 17A will be open and valves 21D and 21A will be configured to allow the expanded air to be released into the atmosphere during said upstroke.

The motor-driven compressor-alternator unit described represents a unit which can operate with bi-energy with, for urban driving for example at slow speed, 50 km/h for example, a zero pollution mode operating only with additional compressed air injection drawn from the storage tank 25 and for highway driving, an operating mode powered by a fossil fuel ensuring large autonomy and very low polluting emissions owing to continuous combustion, catalyzed for instance.

For the purpose of simplification and a better understanding of the drawings, FIGS. 14, 15 and 16 represent a motor-driven compressor-alternator which is not equipped with the ambient thermal energy recovery device as described in FIGS. 7, 8, 9 and 10. It goes without saying that this device can also be introduced without changing the principle of the invention described.

As well as the heater according to the invention, combining fossil fuel and thermochemical reactor as described in FIG. 12, can advantageously be used in this type of dual-energy operation.

Still for the purpose of simplification, all of the drawings hereto concern a unit having two opposed cylinders, however, units having 4 or 6 cylinders operating according to the same principles offer numerous possibilities, notably in terms of number of compression stages and/or ambient thermal energy recovery, or during dual-energy operation wherein a larger number of compression stages can be selected during standalone operation of the unit on the expansion cylinders.

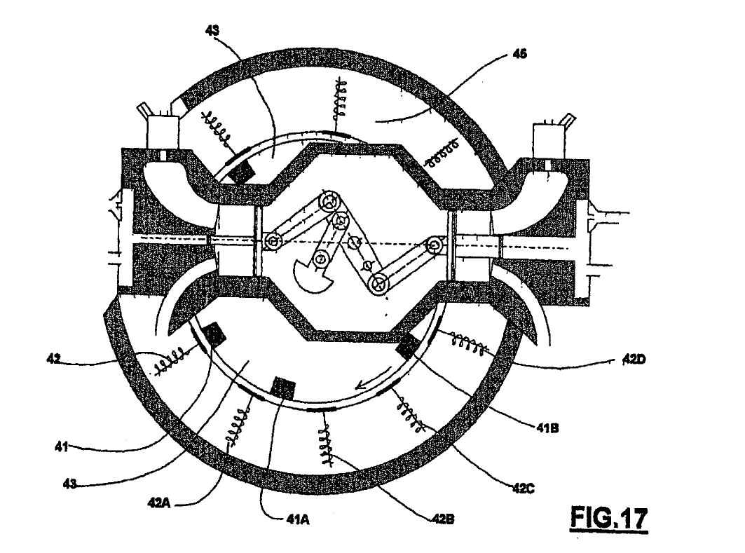

FIG. 17 is a schematic representation of a motor-driven compressor-alternator unit according to the invention showing the motor flywheel 43 in the back ground equipped with well-known arrangements on the permanent magnet electric motors; permanent magnets 41, 41A and 41B, are positioned at regular intervals along the periphery of said motor flywheel forming the stator of the electric motor. Concentrically, integral with the motor crankcase, a stator 45 is mounted on which electromagnets 42, 42A, 42B, 42C and 42D are positioned, opposite and at regular intervals to the permanent magnets. The number of electromagnets is greater than the number of permanent magnets so that the permanent magnets are not in correspondence with the electromagnets at the same time. The electromagnets are controlled by an electronic box and are successively switched on to attract the permanent magnets of the rotor. When a permanent magnet 41, having been attracted by an electromagnet 42, faces the latter, the power of the electromagnet 42 is then cut to release the permanent magnet 41 of its attraction, and the nearest electromagnet 42A, in the opposite rotation direction, of a permanent magnet 41A is thus switched on to attract it and cause the rotor 43 to rotate. The process is repeated with the following elements.

The invention is not limited to the examples described and represented: the materials, the control mechanisms, the valves and shutters, the operating principle of the electric motor-driven alternator, the principle of the thermochemical reactor, and the devices described can vary in the limit of equivalents which produce the same results, without changing the invention described above.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1-29 (canceled).

30. A motor-driven compressor-alternator unit comprising:
pistons;
each piston having a large diameter portion and a smaller diameter portion extending from the large diameter portion;
the large diameter portion sliding within a first cylinder and providing a motor function during expansion followed by exhaust;
the smaller diameter portion sliding within a second cylinder and providing a compressor function; and
an arrangement that at least one of:
inactivates the motor function during compressor operation;
inactivates the compressor function during motor operation; and
activates ambient heat recovery during motor operation.

31. The unit of claim 30, wherein the motor-driven compressor-alternator unit operates in one of mono-energy with compressed air, dual-energy, bi-mode and tri-mode.

32. The unit of claim 30, wherein the smaller diameter portion functions as at least one of a compression thermal energy recovery piston and an ambient thermal energy recovery piston.

33. The unit of claim 30, wherein an expansion function of the smaller diameter portion provides ambient thermal energy recovery.

34. The unit of claim 30, wherein the arrangement comprises a plurality of valves which control air flow between the first and second cylinders.

35. The unit of claim 30, further comprising a plurality of heat exchangers arranged to cool an air flow during a compression stage and arranged to heat the air flow during an ambient thermal energy recovery stage.

36. The unit of claim 30, wherein the smaller diameter portion of one of the pistons comprises a different diameter than the smaller diameter portion of another of the pistons.

37. The unit of claim 30, wherein, during compressor operation, the pistons are structured and arranged to compress air in several decreasing volume stages.

38. The unit of claim 30, wherein the large diameter portion of one of the pistons comprises a different diameter than the large diameter portion of another of the pistons.

39. The unit of claim 38, wherein the one of the pistons and the other of the pistons comprise identical expansion piston surface areas.

40. The unit of claim 38, wherein the one of the pistons and the other of the pistons comprise identical weights so as to provide a correct balancing of the reciprocating masses.

41. The unit of claim 30, further comprising a control system that controls top dead center of the pistons.

42. The unit of claim 41, wherein the control system comprises a first pivotally mounted lever arm and two second arms, each second arm being movably coupled to the first pivotally mounted lever arm and one of the pistons.

43. The unit of claim 42, wherein the first pivotally mounted lever arm comprises a pivot axis which more or less centrally disposed and wherein each second arm is movably coupled to the first pivotally mounted lever arm via a pin.

44. The unit of claim 42, wherein the pistons comprise opposed pistons which are movably mounted about a common axis.

45. The unit of claim 44, wherein the pivot axis comprises a fixed axis which is roughly aligned with the common axis.

46. The unit of claim 43, further comprising a control rod movably coupled to the first pivotally mounted lever arm and a crankshaft.

47. The unit of claim 46, further comprising a pin movably connecting the control rod to the first pivotally mounted lever arm, wherein the pin is arranged between the pivot axis and a connection between the first pivotally mounted lever arm and one of the second arms.

48. The unit of claim 30, further comprising a motor flywheel adapted to be driven by an electric motor.

49. The unit of claim 30, further comprising a motor flywheel adapted to be driven by an electronically controlled electric motor.

50. The unit of claim 30, further comprising a motor flywheel adapted to be driven by an electric motor powered by a household electrical power system.

51. The unit of claim 30, further comprising a system for controlling a rotation speed of the unit via an electric motor, whereby the unit can be operated at high speeds during filling of a high pressure storage tank coupled to the unit and at slower speeds when the high pressure storage tank is filled.

52. The unit of claim 30, wherein the unit is adapted to be driven by an electric motor which can produce electricity during motor operation, whereby the electricity can be used for recharging a battery.

53. The unit of claim 52, wherein the electric motor comprises an alternator which is structured and arranged to rotate at least one revolution so as to start the motor operation of the unit.

54. The unit of claim 53, wherein the alternator and electric motor comprise a motor driven alternator unit which is adapted to occasionally participate in increasing motor torque.

55. The unit of claim 53, wherein the motor driven alternator unit is adapted to function as a speed reducer and is capable of recovering electrical energy during at least one of vehicle deceleration and vehicle braking.

56. The unit of claim 30, further comprising a storage tank which receives compressed air from the pistons and which supplies compressed air to the pistons.

57. The unit of claim 30, further comprising an ambient thermal energy recovery device and a buffer tank coupled to the unit.

58. The unit of claim 30, further comprising a thermal heater structured and arranged to heat compressed air.

59. The unit of claim 58, wherein the thermal heater comprises a burner which uses a fossil fuel, whereby the thermal unit is adapted to at least one of increase a volume of the compressed air passing therethrough and increasing a pressure of the compressed air passing therethrough.

60. The unit of claim 58, wherein the thermal heater uses a solid-gas reaction type thermochemical process based on transformation by evaporation of a reagent fluid contained in an evaporator.

61. The unit of claim 58, wherein the thermal heater uses liquid ammonia in a gas which reacts with a solid reagent contained in a reactor to produce heat.

62. The unit of claim 61, wherein the solid reagent comprises salts.

63. The unit of claim 62, wherein the salts comprises one of calcium, manganese, and barium chlorides.

64. The unit of claim 60, wherein heat that is required to condense the reagent fluid is provided during compressor operation.

65. The unit of claim 64, further comprising an electric heating element which assists in generating the heat.

66. The unit of claim 58, wherein the thermal heater comprises a burner heating system which uses energy from a fossil fuel and a thermochemical heating device.

67. The unit of claim 66, wherein the burner heating system is structured and arranged to regenerate the thermochemical heating device by providing heat required by a reactor to cause a desorption of gaseous ammonia which recondenses in an evaporator, and which continues heating of compressed air passing through a finned pipe of the thermal heater.

68. The unit of claim 30, wherein the unit is adapted to function in a standalone manner and without using a storage tank for storing high pressure compressed air.

69. The unit of claim 30, wherein the unit operates with compressed air supplied by one or more compression stages of the pistons, whereby the compressed air is reheated with a heating system which increases at least one of a volume and a pressure of the compressed air.

70. The unit of claim 69, wherein the unit operates by reinjecting the compressed air into each expansion chamber of each first cylinder, whereby expansion of the compressed air in the first cylinders produces a power stroke.

71. The unit of claim 30, further comprising a thermal heater which receives exhaust air from the first cylinders one of directly and via one or more compression stages, whereby the exhaust air is subjected to a temperature increase.

72. The unit of claim 30, further comprising a safety valve arranged on an exhaust circuit of the unit, whereby the safety valve controls an air pressure and releases excess air into an atmosphere.

73. The unit of claim 30, further comprising a thermal heater and a high pressure compressed air storage tank, whereby, before being introduced into the thermal heater, the unit is adapted to supply compressed air generated during compressor operation to the high pressure compressed air storage tank.

74. The unit of claim 30, wherein the unit is adapted to operate, at low speeds, with compressed air supplied from a high pressure storage tank, whereby the unit generates zero pollution.

75. The unit of claim 30, wherein the unit is adapted to operate, at high speeds, with compressed air supplied from a high pressure storage tank and heated with a thermal heater which uses energy generated from a fossil fuel.

76. The unit of claim 30, wherein the unit is adapted to operate with three energy sources which comprise compressed air from a high pressure storage tank, compressed air which is heated by a thermochemical heater, and compressed air which is heated with a thermochemical heater which comprises a reactor that causes desorption of gaseous ammonia and an evaporator which recondenses the gaseous ammonia.

77. The unit of claim 30, wherein the unit is adapted to operate with four energy sources.

78. The unit of claim 30, wherein the unit is adapted to one of produce electricity for household and provide emergency power.

79. The unit of claim 30, wherein the unit is adapted to provide emergency power and is capable of being switched on automatically, whereby, when the unit is switched on automatically, compressed air contained in a storage tank drives the unit.

80. A combination of the unit of claim 30 and a 2-stroke engine.

81. A combination of the unit of claim 30 and a 4-stroke engine.

82. A combination of the unit of claim 30 and a diesel engine.

83. A combination of the unit of claim 30 and a compressor driven independently of the unit.

84. The unit of claim 30, further comprising a crank lever system coupled to the pistons.

85. A motor-driven compressor-alternator unit comprising:
two pistons;
each piston having a large diameter portion and a smaller diameter portion extending from the large diameter portion;
each large diameter portion sliding within a first cylinder;
each smaller diameter portion sliding within a second cylinder;
levers connecting the two pistons to a crankshaft; and
first valves which allow the unit to operate as a compressor; and
second valves which allow the unit to operate as a motor.

86. The unit of claim 84, further comprising a system which provides for ambient heat recovery during motor operation.

87. A motor-driven compressor-alternator unit comprising:
two pistons;
each piston having a large diameter portion and a smaller diameter portion extending from the large diameter portion;
each large diameter portion sliding within a first cylinder;
each smaller diameter portion sliding within a second cylinder;
levers connecting the two pistons to a crankshaft; and
first valves which allow the unit to operate as a compressor; and
second valves which allow the unit to operate as a motor,
wherein, during motor operation, the first valves are closed, and
wherein, during compressor operation, the first valves are allowed to operate.

88. The unit of claim 84, further comprising at least one pipe for supplying compressed air from one of the first valves associated with one of the two pistons to another of the first valves associated with another of the two pistons.
